(19) United States
(12) Patent Application Publication
(10) Pub. No.: US 2018/0013882 A1
(43) Pub. Date: Jan. 11, 2018

(54) MOBILE ELECTRONIC DEVICE AND OPERATION METHOD THEREFOR

(71) Applicant: Airoha Technology Corp., Hsinchu (TW)

(72) Inventors: Hao-Sheng Hsu, Hsinchu County (TW); Ming-Chou Lee, Hsinchu City (TW); Jen-You Fang, Hsinchu City (TW)

(21) Appl. No.: 15/455,188

(22) Filed: Mar. 10, 2017

Related U.S. Application Data
(60) Provisional application No. 62/358,596, filed on Jul. 6, 2016.

(30) Foreign Application Priority Data
Aug. 22, 2016 (TW) 105126745

(51) Int. Cl. H04M 3/42; G10L 13/08; H04W 4/00; G10L 13/04; H04M 1/2745

(52) U.S. Cl. CPC H04M 3/42042; H04W 4/008; G10L 13/043; G10L 13/08; H04M 1/2745

(57) ABSTRACT

An operation method for a mobile electronic device is provided. The operation method includes: transmitting a calling phone number to a wireless audio product from an operation system of the mobile electronic device via wireless communication, wherein the mobile electronic device is wirelessly connected to the wireless audio product; transmitting the calling phone number to an application software of the mobile electronic device by the wireless audio product; searching a caller name corresponding to the calling phone number by the application software of the mobile electronic device; transmitting the caller name to the wireless audio product by the application software of the mobile electronic device via wireless communication; and playing the caller name by the wireless audio product.

This application claims the benefit of U.S. provisional application Ser. No. 62/358,596, filed Jul. 6, 2016, and the benefit of Taiwan application Serial No. 105126745, filed Aug. 22, 2016, the subject matters of which are incorporated herein by reference.

### BACKGROUND OF THE INVENTION

### Field of the Invention

The invention relates in general to a mobile electronic device and an operation method therefor.

### Description of the Related Art

Mobile electronic devices, such as mobile phones or PC Tablets having communication function, have become indispensable devices to people in their daily life. With a mobile phone or a PC Tablet having communication function, people can make or receive phone calls. To assure traffic safety, for example, when a driver is driving, the driver is better to wear a Bluetooth headset to make or receive phone calls.

In terms of current technologies, how to make the Bluetooth headset play the caller name to the user has become a prominent task to the industries.

### SUMMARY OF THE INVENTION

The invention is directed to a mobile electronic device and an operation method therefor. The user may obtain a caller name from a mobile electronic device and further play the caller name via wireless connection.

According to one embodiment of the present invention, an operation method for a mobile electronic device is provided. The operation method includes: transmitting a calling phone number to a wireless audio product from an operation system of the mobile electronic device via wireless communication, wherein the mobile electronic device is wirelessly connected to the wireless audio product; transmitting the calling phone number to an application software of the mobile electronic device by the wireless audio product; searching a caller name corresponding to the calling phone number by the application software of the mobile electronic device; transmitting the caller name to the wireless audio product by the application software of the mobile electronic device via wireless communication; and playing the caller name by the wireless audio product.

According to another embodiment of the present invention, a mobile electronic device wirelessly connected to a wireless audio product is provided. The mobile electronic device includes an operation system and an application software. The operation system transmits a calling phone number to a wireless audio product via wireless communication. The application software receives the calling phone number from the wireless audio product. The application software searches a caller name corresponding to the calling phone number and further transmits the caller name to the wireless audio product via wireless communication. The wireless audio product plays the caller name.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of an operation method for a mobile electronic device according to an embodiment of the disclosure.

### DETAILED DESCRIPTION OF THE INVENTION

Technical terms of the disclosure are based on general definition in the technical field of the disclosure. If the disclosure describes or explains one or some terms, definition of the terms is based on the description or explanation of the disclosure.

Each of the disclosed embodiments has one or more technical features. In possible implementation, one skilled person in the art would selectively implement part or all technical features of any embodiment of the disclosure or selectively combine part or all technical features of the embodiments of the disclosure.

Currently, the application software of the mobile electronic device still cannot obtain calling phone numbers from the operation system of the mobile electronic device. In the present embodiment of the disclosure, the Bluetooth audio product of the present disclosure receives a phone number from the operation system of the mobile electronic device via Bluetooth communication (such as Bluetooth 3.0). The Bluetooth audio product transmits the phone number to the application software of the mobile electronic device via Bluetooth communication (such as Bluetooth 4.0). The application software of the mobile electronic device can search a contact list to obtain the caller name. The application software of the mobile electronic device transmits the caller name to the Bluetooth audio product via Bluetooth communication, and the Bluetooth audio product plays the caller name.

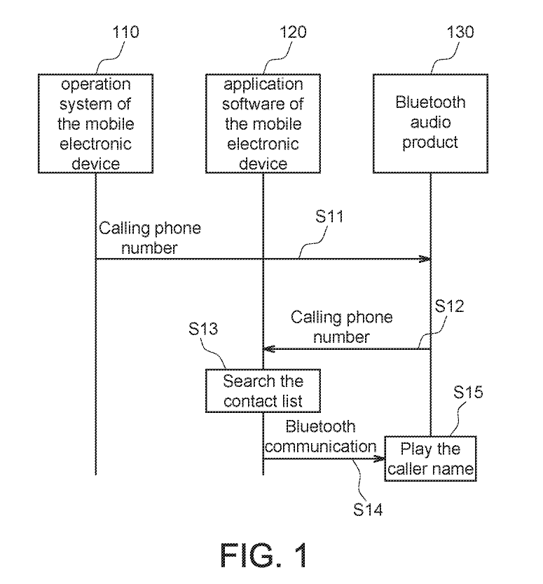

Refer to FIG. 1, a schematic diagram of an operation method for a mobile electronic device according to an embodiment of the disclosure is shown. As indicated in FIG. 1, the mobile electronic device includes a mobile electronic device operation system 110 and a mobile electronic device application software 120. Besides, the mobile electronic device is coupled to the Bluetooth audio product 130 via Bluetooth communication. Exemplarily but not restrictively, the Bluetooth audio product 130 may be realized by a Bluetooth headset, Bluetooth speaker, Bluetooth sound bar and vehicle hands free Bluetooth earpiece. Although the present embodiment of the disclosure is exemplified by Bluetooth communication, the present disclosure is not limited thereto, and may be used in other wireless communication.

In step S11, the mobile electronic device operation system 110 transmits the calling phone number to the Bluetooth audio product 130 via Bluetooth communication. For example, the mobile electronic device operation system 110 transmits the calling phone number to the Bluetooth audio product 130 via Bluetooth 3.0 hands free profile (HFP).

In step S12, Bluetooth audio product 130 transmits the calling phone number received from the mobile electronic device operation system 110 to the mobile electronic device application software 120 via Bluetooth 4.0 connection. That is, in the present embodiment of the disclosure, the Bluetooth audio product 130 is a multi-mode/dual-mode audio product, which at least supports Bluetooth 3.0 and Bluetooth 4.0.

In step S13, the mobile electronic device application software 120 searches a contact list stored in the mobile electronic device to find a caller name corresponding to the calling phone number.

In step S14, the mobile electronic device application software 120 transmits the found caller name to the Bluetooth audio product 130 via Bluetooth communication. In other possible embodiments of the present disclosure, in step S14, the mobile electronic device application software 120 converts the caller name into an audio file by using a text-to-speech (TTS) function, and transmits the audio file to the Bluetooth audio product 130 through an audio path of Bluetooth communication. The Bluetooth audio product 130 plays the audio file to play the caller name.

Or, in other possible embodiments of the present disclosure, after the mobile electronic device application software 120 finds the caller name, the mobile electronic device application software 120 converts the caller name into an audio file by using the TTS function, and further compress the audio file (exemplarily but not restrictively, the audio file is compressed as a way file). Then, the compressed audio file is transmitted to the Bluetooth audio product 130 via a data path of Bluetooth communication. The Bluetooth audio product 130 may decompress the compressed audio file to play the caller name.

In step S15, after Bluetooth audio product 130 receives the caller name, Bluetooth audio product 130 plays the caller name. Thus, without directly searching the contact list, the user still may know who the caller is.

In step S13, after the mobile electronic device application software 120 searched the contact list, if the mobile electronic device application software 120 still cannot find the caller name corresponding to the calling phone number (that is, this calling phone number is not recorded in the contact list), the mobile electronic device application software 120 may request the Bluetooth audio product 130 play the calling phone number.

In other possible embodiments of the present disclosure, part of the internal memory of the Bluetooth audio product 130 may be used to store the audio file (containing the caller names) received from the mobile electronic device application software 120.

Here, the mobile electronic device may be realized by the iPhone product of the Apple Inc., and the mobile electronic device operation system 110 may be realized by the iOS. In terms of current technologies, no application software can directly obtain the calling phone number from the mobile electronic device operation system 110. Therefore, in the present embodiment of the disclosure, the Bluetooth audio product receives phone numbers from the operation system of the mobile electronic device via Bluetooth communication (such as Bluetooth 3.0). The Bluetooth audio product transmits the phone numbers to the application software of the mobile electronic device via Bluetooth communication (such as Bluetooth 4.0). The application software of the mobile electronic device is configured to search the contact list to find the caller name. The application software of the mobile electronic device transmits the caller name to the Bluetooth audio product via Bluetooth communication for the Bluetooth audio product to play the caller name.

Through above embodiments of the disclosure, when the user wears or uses a dual-mode Bluetooth audio product, the dual-mode Bluetooth audio product may play the caller name to immediately inform the user who the caller is, so the user can have better user experience. Conversely, in terms of current technologies, the Bluetooth audio product plays the calling phone number but cannot play the caller name, so the user needs to rely on his/her memory to find out who the caller is.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An operation method for a mobile electronic device, comprising:
transmitting a calling phone number to a wireless audio product from an operation system of the mobile electronic device via wireless communication, wherein the mobile electronic device is wirelessly connected to the wireless audio product;
transmitting the calling phone number to an application software of the mobile electronic device by the wireless audio product;
searching a caller name corresponding to the calling phone number by the application software of the mobile electronic device;
transmitting the caller name to the wireless audio product by the application software of the mobile electronic device via wireless communication; and
playing the caller name by the wireless audio product.

2. The operation method for a mobile electronic device according to claim 1, wherein
the operation system of the mobile electronic device transmits the calling phone number to the wireless audio product via Bluetooth 3.0 hands free profile (HFP), wherein the wireless audio product is a Bluetooth audio product; and
the wireless audio product transmits the calling phone number to the application software of the mobile electronic device via Bluetooth 4.0.

3. The operation method for a mobile electronic device according to claim 2, wherein
the Bluetooth audio product is a multi-mode/dual-mode audio product.

4. The operation method for a mobile electronic device according to claim 1, wherein in the step of transmitting the caller name to the wireless audio product by the application software of the mobile electronic device,
the application software of the mobile electronic device converts the caller name into an audio file and transmits the audio file to the wireless audio product by using a text-to-speech (TTS) function, wherein the wireless audio product plays the audio file to play the caller name.

5. The operation method for a mobile electronic device according to claim 1, wherein in the step of transmitting the caller name to the wireless audio product by the application software of the mobile electronic device,
the application software of the mobile electronic device converts the caller name into an audio file by using a TTS function, the application software of the mobile electronic device compresses the audio file as a compressed audio file, and further transmits the compressed audio file to the wireless audio product; and
the wireless audio product decompresses the compressed audio file to play the caller name.

6. A mobile electronic device wirelessly connected to a wireless audio product, the mobile electronic device comprising:
an operation system, configured to transmit a calling phone number to the wireless audio product via wireless communication; and
an application software, configured to receive the calling phone number from the wireless audio product, wherein the application software searches a caller name corresponding to the calling phone number and further transmits the caller name to the wireless audio product via wireless communication, and the wireless audio product plays the caller name.

7. The mobile electronic device according to claim 6, wherein
the operation system of the mobile electronic device transmits the calling phone number to the wireless audio product via Bluetooth 3.0 hands free profile (HFP), wherein the wireless audio product is a Bluetooth audio product; and
the application software of the mobile electronic device receives the calling phone number from the wireless audio product via Bluetooth 4.0.

8. The mobile electronic device according to claim 7, wherein
the Bluetooth audio product is a multi-mode/dual-mode audio product.

9. The mobile electronic device according to claim 6, wherein
the application software of the mobile electronic device converts the caller name into an audio file by using a TTS function, and
the application software of the mobile electronic device transmits the audio file to the wireless audio product, wherein the wireless audio product plays the audio file to play the caller name.

10. The mobile electronic device according to claim 6, wherein
the application software of the mobile electronic device converts the caller name into an audio file by using a TTS function,
the application software of the mobile electronic device compresses the audio file as a compressed audio file,
the application software of the mobile electronic device transmits the compressed audio file to the wireless audio product, and
the wireless audio product decompresses the compressed audio file to play the caller name.
